(19) United States
(12) Patent Application Publication
(10) Pub. No.: US 2005/0175266 A1
(43) Pub. Date: Aug. 11, 2005

(54) ELECTRICALLY CONDUCTIVE SELF-LUBRICATING BEARING SYSTEM AND A METHOD FOR IMPLEMENTING SAME

(75) Inventors: Randy Noack, East Hampton, CT (US); Mathew Mormino Jr., Suffield, CT (US); Arkadi Zak, Springfield, MA (US); Jeffrey Post, South Windsor, CT (US); Mark Broding, Ellington, CT (US)

Correspondence Address: CANTOR COLBURN, LLP, 55 GRIFFIN ROAD SOUTH, BLOOMFIELD, CT, 06002, US

(73) Assignee: KAMATICS CORPORATION, Bloomfield, CT (US)

(21) Appl. No.: 10/708,144

(22) Filed: Feb. 11, 2004

(51) Int. Cl. F16C 33/02

(52) U.S. Cl. 384/277

(57) ABSTRACT

A method and system for an electrically conductive self-lubricating bearing includes a mating structure having a mating surface; an electrically conductive substrate, wherein the substrate includes a substrate surface having a plurality of valleys defined by at least one electrically conductive rib extending therefrom; and a lubricating material, wherein the lubricating material is disposed within the plurality of valleys, an exposed surface of the lubricating material substantially flush with an end defining a length of the rib so as to be communicated with the substrate surface and the mating surface, wherein the rib is in electrical communication with the mating surface.

### BACKGROUND OF INVENTION

This invention relates generally to a self-lubricating bearing system and a method for implementing a self-lubricating bearing system and more particularly to an electrically conductive self-lubricating bearing system and a method for implementing the same.

Most existing bearing system designs utilize a thin dry film lubricant or grease to lubricate bearings used in applications that experience high loads such as static joints, applications that experience oscillatory motions or applications that experience high levels of vibration or micro-motion. However, one of the main problems observed with these designs is that the dry film lubricant or grease migrates out of the bearing resulting in fretting, galling, seizure or migration of the bearing in the bearing housing (rotational and/or axial movement). In an attempt to address this problem, bearing system designers have tried to apply self-lubricating PTFE or Teflon® fabrics and/or non-peelable PTFE or Teflon® liner systems.

In addition, previous self lubricating bearings used in aerospace applications for over twenty-five years are not electrically conductive, and in fact, act as insulators for electrical current. Bearings used in such applications must include a conductive path to dissipate static electricity that is built up flying through clouds and to dissipate electrical current during landing with a path to ground. In the past, aircraft manufacturers have had to use a separate wire called a “jump strip” to pass current around the insulating self lubricating bearing which results in additional complexity and cost.

Therefore, there is a need for an electrically conductive self-lubricating bearing system and a method for implementing the electrically conductive self-lubricating bearing system, wherein the self-lubricating bearing system satisfies desired stiffness, load carrying requirements, and wear life, and wherein the method and system may be implemented without a using a bypass jumper wire to allow electrical current or charges to be passed through the bearing in an inexpensive and reliable manner.

### SUMMARY OF INVENTION

An electrically conductive self-lubricating bearing system includes: a mating structure having a mating surface; an electrically conductive substrate, wherein the substrate includes a substrate surface having a plurality of valleys defined by at least one electrically conductive rib extending therefrom; and a lubricating material, wherein the lubricating material is disposed within the plurality of valleys, an exposed surface of the lubricating material substantially flush with an end defining a length of the rib so as to be communicated with the substrate surface and the mating surface, wherein the rib is in electrical communication with the mating surface.

A method for implementing an electrically conductive self-lubricating bearing system comprising: defining a plurality of valleys within a metallic substrate surface with at least one electrically conductive rib extending therefrom; cleaning the substrate surface so as to remove impurities from the substrate surface; bonding a lubricating material to the substrate surface so as to dispose a defined thickness of the lubricating material on the substrate surface, the lubricating material including a polymer resin having lubricating particles embedded within the polymer resin; curing the lubricating material to adhesively bond the lubricating material to the substrate; removing at least one of the lubricating material and extending rib material such that an exposed surface of the lubricating material is substantially flush with an end defining a length of the rib; and associating the substrate with a mating structure having a mating surface, wherein the mating structure is disposed relative to the substrate such that the lubricating material is disposed between the substrate surface and the mating surface, the rib being in electrical communication with the mating surface.

In an alternative embodiment, the lubricating material may include a woven fabric material that is combined with the resin and allowed to cure so that the fabric material fills the recesses of the substrate. Excess resin is removed keeping the rib substantially flush with an exposed surface of the self lubricating fabric material while the rib is in electrical communication with the mating surface.

### BRIEF DESCRIPTION OF DRAWINGS

The above discussed and other features and advantages will be appreciated and understood by those skilled in the art from the following detailed description and drawings, wherein like elements are designated by like numerals in the several figures.

Referring now to the drawings:

FIG. 1 is a cross-sectional side view during intermediary processing of a substrate having a plurality of ribs extending therefrom and at least one of excess lubricating material and elongated ribs shown in phantom aligned with a mating surface, showing ribs defining self-lubricating reservoirs in accordance with an exemplary embodiment;

FIG. 2 is a cross-sectional side view of the substrate communicated with a mating surface, showing the lubricating material disposed in the self-lubricating reservoirs and metal ribs substantially flush with an exposed surface of the lubrication material;

FIG. 3 is a flow diagram describing a method for implementing a self-lubricating bearing system in accordance with an exemplary embodiment;

FIG. 4 is a perspective view of an exemplary embodiment of an electrically conductive self-lubricating bushing;

FIG. 5 is a perspective view of an exemplary embodiment of an electrically conductive self-lubricating spherical bearing assembly illustrating a shaft extending therethrough in phantom; and

FIG. 6 is a perspective view of a spherical ball removed from the spherical bearing assembly of FIG. 5 illustrating outboard electrical conductive ribs for electrical communication with an outside race of the assembly and an interior centrally disposed rib for electrical communication with the shaft.

### DETAILED DESCRIPTION

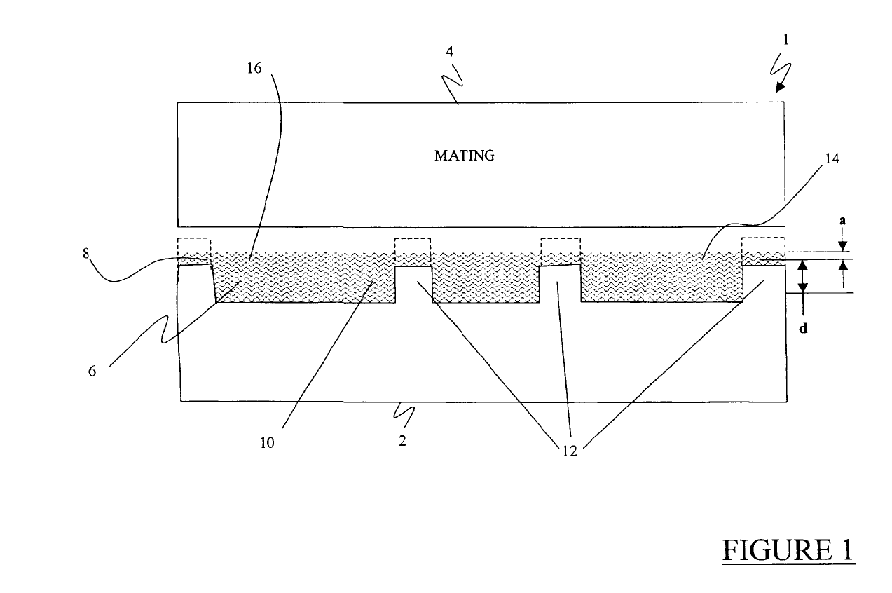

Referring to FIG. 1, an electrically conductive self-lubricating film/metallic bearing system 1 is shown during intermediary processing and described. In accordance with an exemplary embodiment, a self-lubricating bearing system 1 is illustrated and preferably includes a substrate 2, a mating structure 4 and a lubricating material 6. Substrate 2 preferably includes a substrate surface 8 having at least one rib 12 and a plurality of valleys 10 defined therein, wherein each valley 10 includes a valley depth d. Mating structure 4 includes a mating surface 14, wherein mating surface 14 is preferably a hard, smooth metallic surface. In accordance with an exemplary embodiment, mating structure 4 is preferably a chrome plated metallic surface. However, mating structure 4 may be constructed of a hardened corrosion resistant and/or stainless steel and/or metallic substrate that has been chrome plated, plasma sprayed and/or high velocity oxy fuel (HVOF) coated. In addition, mating structure 4 may be constructed of any material or combination of materials suitable to the desired end purpose. In accordance with an exemplary embodiment, mating structure 4 may be any hard, smooth metallic surface suitable to the desired end purpose, such as a shaft in a bushing product or against a ball in a spherical bearing product.

In accordance with an exemplary embodiment, substrate 2 is a metallic substrate preferably constructed of copper nickel tin, beryllium copper, aluminum nickel bronze, copper, brass, aluminum, and/or corrosion resistant steel. However, substrate 2 may be constructed from any material suitable to the desired end purpose.

In accordance with an exemplary embodiment, recesses or the plurality of valleys 10 are defined by at least one rib 12 when substrate surface 8 is machined such that thin recesses are formed into the metallic substrate 2. The recesses can be machined in any pattern such as, but not limited to concentric rings, along a helix, along a very coarse thread pitch (See FIG. 4), a diamond pattern, etc. The machining of the recesses forms thin raised ribs 12 (four shown in FIG. 1).

In accordance with an exemplary embodiment, lubricating material 6 is preferably constructed from polymer (polyester) resin, lubricant particles such as, but not limited to polytetrafluorethylene (PTFE), Teflon®, fluorinated ethylene propylene (FEP), molybdenum disulfide, molybdenum, graphite, polyester, and other suitable filler particles to form a self-lubricating bearing liner system. In accordance with an exemplary embodiment, lubricating material 6 (resin system) may be an epoxy, polyimide, urethane, acrylic, phenolic, polyester, or any other lubricating material 6 suitable to the desired end purpose. Moreover, lubricating material 6 preferably includes polytetrafluorethylene (PTFE), Teflon®, fluorinated ethylene propylene (FEP), molybdenum disulfide, molybdenum, graphite, polyester particles and/or fibers. These particles and/or fibers are preferably commercially available and sold particles that are mixed with a liquid polymer resin that form a liquefied slurry mixture that turns into a homogenous solid material when the slurry mixture is cured (baked) during the fabrication process. Furthermore, lubricating material 6 is preferably constructed from several types of resins so as to advantageously provide operational capability for thermal environments from about −200° F. to about +700° F.

Lubricating material 6 is preferably disposed relative to substrate surface 8 so as to form a film 16 having a defined thickness a, coating the surface area of substrate surface 8. Thickness a may be a desired thickness to achieve a bearing operational life suitable for its desired end purpose. In addition, lubricant material 6 is also preferably disposed relative to substrate surface 8 so as to be disposed within plurality of valleys 10. In particular, lubricant material 6 may be applied to a level, corresponding with thickness a, just above a height of the thin ribs 12 (four shown) which have been machined into the metallic substrate surface 8 in one embodiment. In another alternative embodiment, ribs 12 may extend past the applied lubricant material 6 as shown in phantom. Preferably, lubricant material 6 is applied so as to be substantially flush with the thin ribs 12 to reduce material waste.

In accordance with an exemplary embodiment, thickness a of film 16 is preferably about 0.001 to about 0.030 inches thick. The recesses or plurality of valleys 10 can be machined in any pattern such as, but not limited to concentric rings, along a helix, along a very coarse thread pitch, a diamond pattern, etc. The machining of the recesses 10 forms the four thin raised ribs 12 illustrated in FIG. 1.

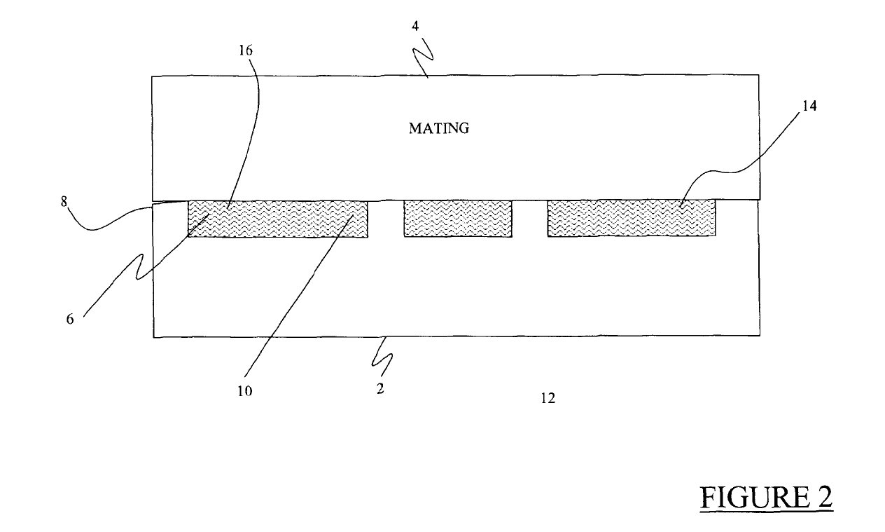

Referring now to FIG. 2, the self-lubricating liner material 6 is then partially removed or machined back to expose the metallic substrate ribs 12 that are formed from prior machining of the recesses. Excess material 16 is removed from the ends defining a length of each rib 12 due to a manufacturing process such as by sanding, polishing, or light machining keeping the ribs 12 flush with an exposed surface of the self lubricating liner material 16 that is bonded into each of the plurality of valleys 10. It will be recognized by one skilled in the pertinent art that removal of excess resin as discussed above may not be required if substrate 2 is molded to finish size.

In an alternative embodiment, the electrically conductive bearing system may be created in a similar way to that described with respect to FIGS. 1 and 2 above. More specifically, lubricant material 6 includes using a PTFE or Teflon®, FEP, graphite, or polyester fabric material that is comprised of PTFE or Teflon®, FEP, graphite, or polyester threads which are woven together with other threads including but not limited to polyester, cotton, nylon, arimid, glass fiber, or carbon fiber. This fabric is combined with a resin system comprised of, but not limited to, polyimide, urethane, epoxy, acrylic, phenolic, polyester in either a liquid form or by prior B-staging of the resin into the fabric. The fabric of the proper thickness a is then placed into the machined recesses 10 and is cured so that the fabric fills the recesses of the metallic substrate 2 up to a level corresponding with a height of the ribs 12 that have been formed by machining the recesses into the substrate material. Referring to FIG. 2, any excess resin may then removed from the ribs by sanding, polishing, or light machining keeping the end defining a length of each rib flush with an exposed surface of the self lubricating fabric that is bonded into the recesses. Alternatively, any excess resin may be removed when the fabric is pressed into the machined recesses 10 of substrate 2 with the ribs 12 acting as a mechanical stop, thus eliminating any machining and ensuring that the ribs 12 are substantially flush with an exposed surface of the cured lubricant material 6.

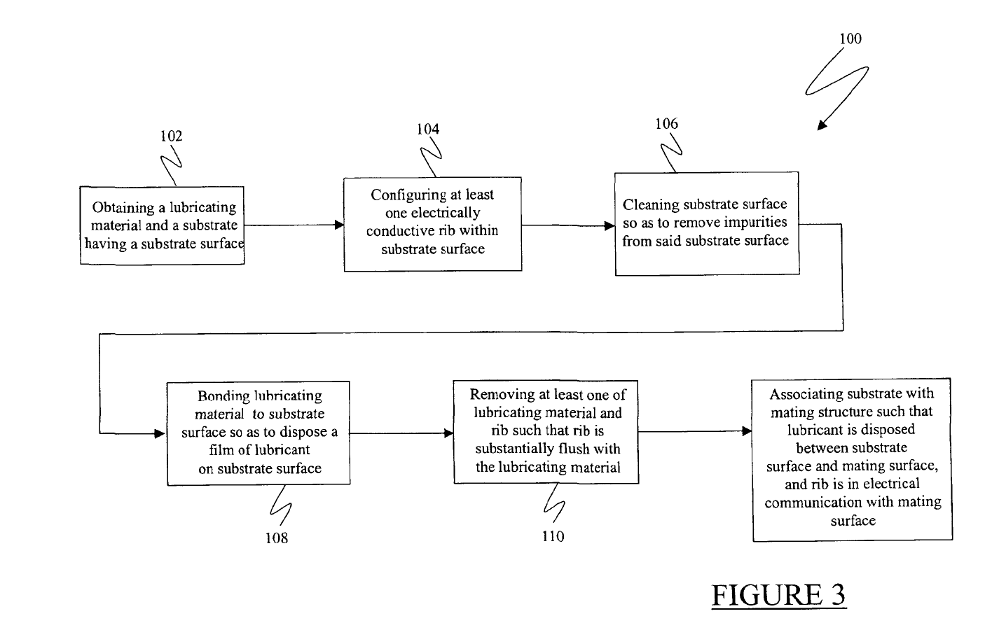

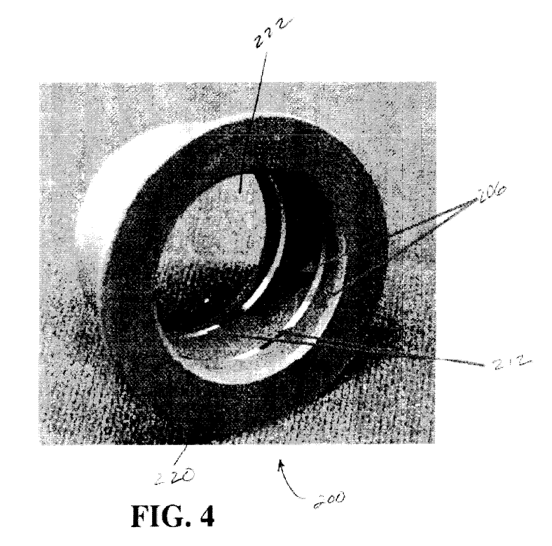

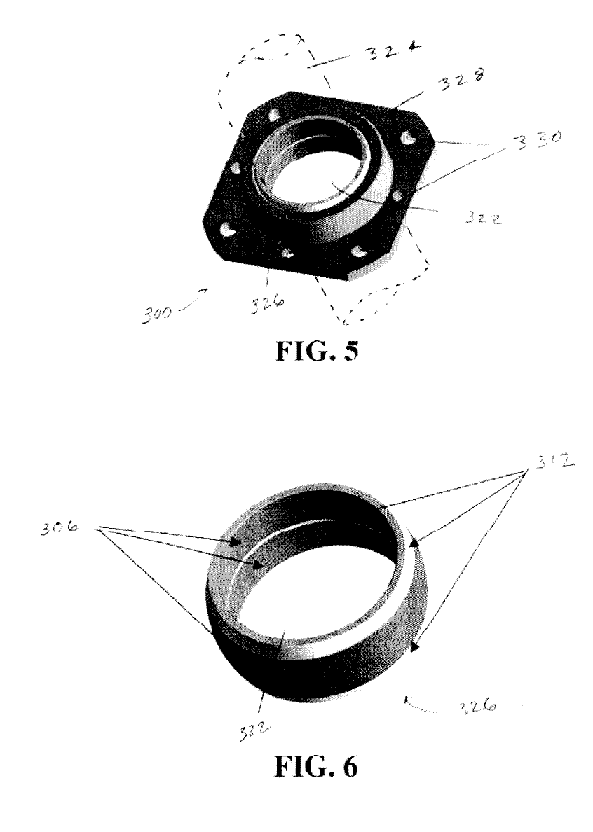

Referring to FIG. 3, a method for implementing an electrically conductive thin self-lubricating film/metallic bearing system 100 is shown and described. In accordance with an exemplary embodiment, a lubricating material 6 and a substrate 2 having a substrate surface 8 is obtained as shown in step 102. In addition, a mating structure 4 having a mating surface 14 is also obtained. Substrate surface 8 is then processed so as to create a plurality of valleys 10 defined by at least one rib 12 as shown in step 104.

Substrate surface 8 is optionally processed by mechanically roughening substrate surface 8 via abrasive grit blast, controlled peening, a mechanical knurling process, drilling, machining and/or via any method and/or device suitable to the desired end purpose, such as chemical techniques (e.g., etching) or other mechanical techniques.

In accordance with an exemplary embodiment, substrate 2 is preferably constructed using an electrically conductive metal and/or a combination of metals that are corrosion resistant and that are selected for their resistance to galling and/or fretting while in contact with mating surface 14. However, substrate 2 may be constructed using any material suitable to the desired end purpose, such as copper nickel tin, beryllium copper, aluminum nickel bronze, copper, brass, aluminum, and corrosion resistant steel.

Once substrate surface 8 is processed, substrate surface 8 is then chemically cleaned so as to remove any impurities as shown in step 106. In accordance with an exemplary embodiment, substrate surface 8 is preferably cleaned using a chemical etchant. However, substrate surface 8 may be cleaned using any alkaline cleaning solution and/or any solvent, method and/or device suitable to the desired end purpose.

Lubricating material 6 is then applied to substrate 2 as shown in step 108. In accordance with an exemplary embodiment, lubricating material 8 is preferably applied so as to form a desired thickness film 16 on substrate surface 8 and so as to be contained within plurality of valleys 10. More preferably, the self-lubricating liner material 6 is applied to a level just above the height of the thin ribs 12 extending from substrate 2 which have been machined into the surface 8 of the bearing metallic substrate 2.

Once lubricating material 6 has been bonded and allowed to cure on substrate surface 8, any excess self-lubricating liner material 6 is removed by machining back to expose the metallic substrate ribs 12 that are formed from prior machining of the recesses. Excess material 6 is removed from the ribs 12 by sanding, polishing, or light machining keeping the ribs 12 generally flush with the exposed surface of the self lubricating material 6 that is bonded into the valleys 10. Alternatively, any extending ribs 12 extending past the cured liner material 6 are likewise machined to be substantially flush with an exposed surface of the liner material 6.

Substrate 2 is then disposed so as to be associated with mating structure 4 as shown in step 110. In accordance with an exemplary embodiment, mating structure 4 is preferably disposed relative to substrate 2 such that lubricating material 6 is disposed between substrate surface 8 and mating surface 14, while ribs 12 are in electrical communication with mating surface 14 providing an electrical conductive path therethrough.

In accordance with an exemplary embodiment, as the bearing is used in service, a very thin film of lubricating material, which is a by product from the natural self lubricating function of the bearing, provides just enough lubrication to prevent wear damage to the mating sliding surface from the thin ribs in the self lubricating bearing system. As the bearing is actuated the ribs are also self cleaning as the metal rib rubs against the metallic mating surface (shaft, spherical ball) providing a clean contact for good electrical conductivity. Testing conducted by the assignee of this type of bearing system has shown electrically resistance of less than 1 ohm which meets the requirements specified by aircraft manufacturers.

In accordance with an exemplary embodiment, the self-lubricating material is advantageously contained in valleys 10 formed by processing substrate 2. As this bearing experiences oscillations, vibrations, or micro-motion, lubricating material 6 contained within valleys 10 is continually dispersed to form a lubricant film transfer to the mating surface 14 while the plateaus 12 of substrate 2 provide an electrical conductive path thereto. This unique type of construction advantageously prevents the escape of particles of lubricating material 6 from the wear zone as the valleys 10 defined by plateaus or ribs 12 act to catch and retain lubricating material 6 by plateaus 12 of substrate 2 as the bearing system 1 oscillates and/or rotates.

In accordance with an exemplary embodiment, mating structure 8 may be an integral component of bearing system 1, such as a spherical ball is a spherical bearing as in FIGS. 5 and 6, and/or mating structure 8 may be a separate component, such as a shaft which is inserted into a bushing and thus becomes mating structure 8 as in FIG. 4.

Referring now to FIG. 4, an exemplary embodiment of an electrically conductive self-lubricating bushing 200 is illustrated. Bushing 200 is a metallic substrate as described above having a generally cylindrical shape except for a flange 220 extending from one end. The cylindrical portion of bushing 200 defines a cylindrical aperture 222. Aperture 222 is further defined by a rib 212 configured in a course thread pitch, such that two threads illustrated in FIG. 4 correspond to a continuous thread but depicted as two ribs 212 as seen in FIG. 4. The continuous rib 212 provides a electrical communication through bushing 200 to a shaft (not shown) disposed in aperture 222. Lubricant material 206 is disposed in valleys (not shown) defined by rib 212 extending radially inwardly with respect to aperture 222. As described above, lubricant material 206 is machined to keep rib(s) 212 substantially flush with an exposed surface of self-lubricating material 206 that is bonded in the valleys, while rib(s) 212 provide an electrical conduction path through bushing 200 and to a shaft disposed therein.

Referring now to FIGS. 5 and 6, an exemplary embodiment of an electrically conductive self-lubricating spherical bearing assembly 300 illustrating a shaft 324 extending therethrough in phantom is shown in FIG. 5, while the spherical bearing 326 is shown removed from the assembly 300 in FIG. 6. Spherical bearing assembly 300 includes spherical bearing 326 disposed in a bearing outer race 328 of assembly 300. Bearing outer race 328 is configured to be secured via apertures 330 to a frame, for example, while spherical bearing 326 allows rotation of shaft 324 disposed therein and outer race 328 allows pivotal movement about a shaft portion disposed in the spherical bearing 326.

Spherical bearing 326 defines an aperture 322 configured to have shaft 324 disposed therein. Shaft 324 is in electrical communication with a first rib 312 defining an interior central region of aperture 322. Two more ribs 312 define outboard ends of spherical bearing 326 and are configured to provide electrical communication with outer race 328 when spherical bearing 326 is disposed therewith. Self-lubricating material 306 is bonded in valleys (not shown) defined by ribs 312 to keep ribs 312 substantially flush with an exposed surface of the self-lubricating material 306 that is bonded in the corresponding valleys on both sides of bearing 326.

The bearing types that are contemplated using an electrically conductive bearing system and method discussed above include, for example, but limited thereto, bushings (sleeve or flange types), spherical bearings that provide misalignment capability, track roller and airframe type cam follower bearings, and thrust bearings.

The self-lubricating bearing system and method described herein allows for the mating metallic surface (e.g., shaft, spherical ball) that the self lubricating liner system slides against to also come in contact with thin metallic ribs in the self lubricating bearing. These thin ribs form a continuous electrically conductive path. As the bearing is used in service, a very thin film of lubricating material, which is a by product from the natural self lubricating function of the bearing, is deposited on these thin ribs to provide just enough lubrication to prevent wear damage to the mating sliding surface from the thin ribs in the self lubricating bearing system. As the bearing is actuated, the ribs are also provide self cleaning as the metal rib rubs against the metallic mating surface (e.g., shaft, spherical ball) providing a clean contact for good electrical conductivity. This type of bearing system has shown electrically resistance of less than one ohm, which meets the requirements specified by aircraft manufacturers.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An electrically conductive self-lubricating bearing system comprising:
a mating structure having a mating surface;
an electrically conductive substrate, wherein said substrate includes a substrate surface having a plurality of valleys defined by at least one electrically conductive rib extending therefrom; and
a lubricating material, wherein said lubricating material is disposed within said plurality of valleys, an exposed surface of said lubricating material substantially flush with an end defining a length of said rib so as to be communicated with said substrate surface and said mating surface, wherein said rib is in electrical communication with said mating surface.

2. The system according to claim 1, wherein said mating structure is constructed of metal.

3. The system according to claim 1, wherein said mating structure is constructed of metal having one of hardened corrosion resistant steel, stainless steel, and metallic substrate that has been one of chrome plated, plasma sprayed and high velocity oxy fuel (HVOF) coated.

4. The system according to claim 1, wherein said substrate is constructed of a metallic material having corrosion resistant properties.

5. The system according to claim 4, wherein said metallic material includes one of copper nickel tin, beryllium copper, aluminum nickel bronze, copper, brass, aluminum, and corrosion resistant steel.

6. The system according to claim 1, wherein said lubricating material is constructed of polymer resin.

7. The system according to claim 1, wherein said lubricating material is constructed of one of Teflon®, PTFE material, and graphite material.

8. The system according to claim 1, wherein said lubricating material is capable of operating in thermal environments from about −200° F. to about +700° F.

9. The system according to claim 1, wherein said lubricating material is a fabric including at least one of lubricating thread and lubricating fiber woven together with other threads and combined with a resin in one of liquid form and prior to B-staging of said resin on said fabric.

10. The system according to claim 9, wherein said other threads include at least one of polyester, cotton, nylon, arimid, glass fiber, and carbon fiber.

11. The system according to claim 1, wherein said lubricating material including a polymer resin including lubricating particles embedded within the polymer resin, said lubricating material adhesively bonded to said substrate.

12. The system according to claim 11, said lubricant particles including polytetrafluorethylene (PTFE), fluorinated ethylene propylene (FEP), molybdenum disulfide, molybdenum, graphite, and polyester.

13. The system according to claim 11, wherein said polymer resin is made from one of epoxy, polyimide, urethane, acrylic, polyester, and phenolic.

14. The system according to claim 1, wherein said substrate has a uniform roughness.

15. A method for implementing an electrically conductive self-lubricating bearing system comprising:
defining a plurality of valleys within a metallic substrate surface with at least one electrically conductive rib extending therefrom;
cleaning said substrate surface so as to remove impurities from said substrate surface;
bonding a lubricating material to said substrate surface so as to dispose a film of said lubricating material on said substrate surface, said lubricating material including a polymer resin including lubricating particles embedded within the polymer resin;
curing said lubricating material to adhesively bond said lubricating material to said substrate;
removing any at least one of said lubricating material and extending rib such that an exposed surface of said lubricating material is substantially flush with an end defining a length of said rib; and
associating said substrate with a mating structure having a mating surface, wherein said mating structure is disposed relative to said substrate such that said lubricating material is disposed between said substrate surface and said mating surface, said rib in electrical communication with said mating surface.

16. The method according to claim 15, wherein said lubricating material is a fabric including at least one of lubricating thread and lubricating fiber woven together with other threads and combined with a resin in one of liquid form and prior to B-staging of said resin on said fabric.

17. The method according to claim 15, wherein said defining includes machining recesses in said metallic surface in any pattern.

18. The method according to claim 17, wherein said any pattern includes one of concentric rings, a helix, a course thread pitch, and a diamond pattern.

19. The method according to claim 15, wherein said defining includes chemical etching.

20. The method according to claim 15, wherein said machining includes one of sanding, polishing, and light machining excess lubricating material disposed over said end defining said length of said rib.
